(19) United States
(12) Patent Application Publication
(10) Pub. No.: US 2025/0216015 A1
(43) Pub. Date: Jul. 3, 2025

(54) SYSTEMS AND METHODS FOR USE IN MAINTAINING CONDUITS AND PIPES

(71) Applicant: PPG ARCHITECTURAL FINISHES, INC., Pittsburgh, PA (US)

(72) Inventor: Douglas W. Motzno, Knightdale, NC (US)

(73) Assignee: PPG ARCHITECTURAL FINISHES, INC., Pittsburgh, PA (US)

(21) Appl. No.: 18/853,457

(22) PCT Filed: Apr. 10, 2023
(86) PCT No.: PCT/US2023/065567

§ 371 Date: Oct. 2, 2024

Related U.S. Application Data
(60) Provisional application No. 63/329,470, filed on Apr. 10, 2022.

(51) Int. Cl. F16L 55/30; B08B 9/043

(52) U.S. Cl. CPC F16L 55/30; B08B 9/043

(57) ABSTRACT

Systems and methods for use maintaining a pipe are described herein. In some cases, systems for positioning an umbilical supply line are provided herein. The system may include an umbilical supply line (62), a plurality of spaced apart annular disk assemblies (61), an umbilical tether drive system, and a reeling apparatus. The umbilical tether drive system can include at least one drive element and a drive motor to drive the drive element. Systems for controlling temperature and humidity conditions in a pipe are also described herein. The system may include an air conditioning apparatus configured to discharge air into a pipe; at least one sensor configured to detect at least one of temperature, air velocity, and/or position of a centralizer; and a control unit configured to adjust the air conditions in the pipe based on the data from the at least one sensor.

### CROSS-REFERENCE TO RELATED APPLICATION

This application claims priority to U.S. Provisional Patent Application 63/329,470, filed Apr. 10, 2022, the entire disclosure of which is hereby incorporated herein by reference.

### FIELD

Described herein are systems and methods used in the field of conduits and pipes, including maintaining such conduits and pipes after installation into a pipeline system.

### BACKGROUND

Pipeline systems are widely used to transport water, sewage, petroleum products and other materials that can be reduced to a flowable form. Often pipeline distribution is concealed, for example, placed underground, inside a structure such as a wall, or in otherwise difficult to access regions. Over time, pipeline systems often require maintenance, for example cleaning to remove buildup of undesirable deposits along the interior walls of the pipe, and in turn, access to the interior of a pipe is desired. As another example, such maintenance may include treating the interior walls of the pipe with a protective coating, which similarly requires access to the interior of the pipe in potentially difficult regions to access.

### SUMMARY

The present disclosure is directed to a system for positioning an umbilical supply line, the system comprising an umbilical supply line; a plurality of spaced apart annular disk assemblies, wherein each annular disk assembly defines an aperture through which the umbilical supply line is positioned; an umbilical tether drive system comprising at least one drive element driven by a drive motor, the drive element having a plurality of protrusions; and a reeling apparatus comprising an axle that receives the umbilical supply line therearound.

The present disclosure is further directed to a system for positioning an umbilical supply line, the system comprising an umbilical supply line comprising a plurality of catch structures positioned on, affixed to, and/or connected to the umbilical supply line; an umbilical tether drive system comprising at least one drive element driven by a drive motor, the drive element having a plurality of protrusions, wherein each of the plurality of protrusions comprise a complementary shape to the plurality of catch structures positioned on, affixed to, and/or connected to the umbilical supply line; and a reeling apparatus comprising an axle that receives the umbilical supply line therearound, wherein upon the drive motor driving the at least one drive element, the umbilical tether drive system deploys and/or retracts the umbilical supply line from the reeling apparatus.

The present disclosure is further directed to a system for controlling temperature and humidity conditions in a pipe, the system comprising an air conditioning apparatus configured to discharge air into a pipe; at least one sensor configured to detect at least one of temperature, air velocity, and/or position of a centralizer; and a control unit configured to adjust the air conditions in the pipe based on the data from the at least one sensor.

### BRIEF DESCRIPTION OF FIGURES

FIG. 1 shows a system for cleaning and maintaining a pipeline system.

FIG. 2 shows a partial view of a pipe having a system for cleaning a pipe positioned therein.

FIG. 3 shows a partial view of a pipe having a portion of a system for cleaning a pipe positioned therein.

FIG. 4 shows a partial view of a pipe having a system for cleaning a pipe, showing a centralizer positioned at an elbow of a pipe.

FIG. 5 shows a photo of an umbilical tether drive system.

FIG. 6 shows a photo of an umbilical tether drive system.

FIG. 7A shows a photo of an umbilical tether drive system in a first position.

FIG. 7B shows a photo of the umbilical tether drive of FIG. 7A in a second position.

FIG. 8 is a block diagram showing an overview of a control system for a system for maintaining a pipeline.

FIG. 9 is a block diagram showing an overview of a control system for a system for maintaining a pipeline.

FIG. 10 is a block diagram showing a control system for a system for maintaining a pipeline.

FIG. 11 is a block diagram showing a control system for a system for maintaining a pipeline.

FIG. 12 is a block diagram showing a control system for a system for maintaining a pipeline.

FIG. 13 is a block diagram showing a control system for a system for maintaining a pipeline.

FIG. 14 is a block diagram showing a control system for a system for maintaining a pipeline.

FIG. 15 is a schematic of a straight section of a pipe and spin disk.

FIG. 16 is a schematic of an elbow section of a pipe and spin disk.

FIG. 17 shows a diagram of a spin disk and dimensions for measurements shown in Table 1.

FIG. 18 shows a centralizer positioned in a pipe having a rod and a spin disk.

FIG. 19 shows a centralizer positioned in a pipe having a rod and a spin disk

FIG. 20 is a graph showing results of calculations for a 30 inch-diameter pipe.

FIG. 21 shows a schematic of a section of pipe and exemplary air flow profile.

### DETAILED DESCRIPTION

Provided herein are systems, methods, and apparatus useful for maintaining a pipe, for example, cleaning, inspecting, repairing, and/or lining of an interior of a pipe system. As used herein, the terms “pipes” and “conduit” are used interchangeably. The systems and methods can provide a platform for deploying tooling required for pipe wall preparation and installation of spray applied materials in varied diameter piping, for example, pipes having an internal diameter of six inches or greater. As pipe systems are often difficult to access, e.g., being underground or inside wall structures, and often span a long distance, embodiments of the systems and methods described herein can be used to avoid extensive digging or disassembly of pipe system. In some cases, embodiments of the systems and methods described herein can provide a system that can maneuver efficiently throughout complex piping geometrics. The systems and methods described herein can also offer methods for controlling the conditions within a pipe, e.g., to optimize conditions for application of lining materials.

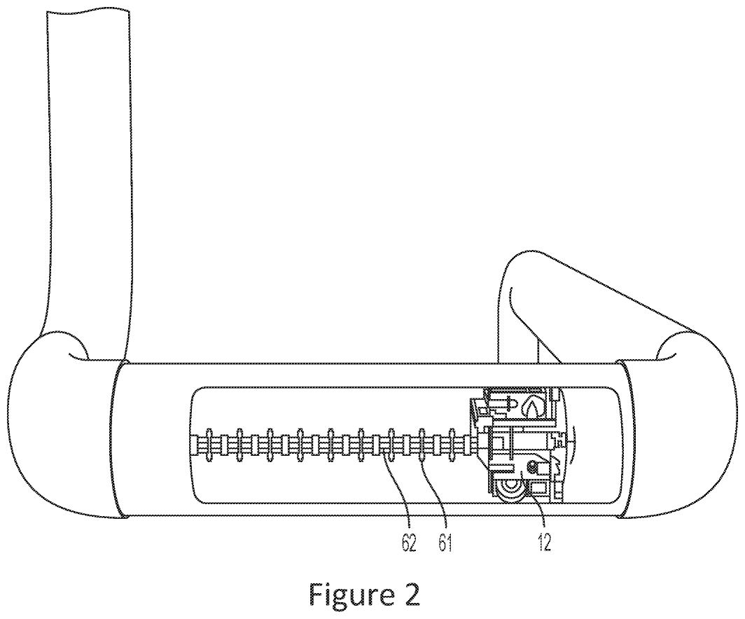

The systems and methods described herein can provide systems that are capable of navigating and processing complex pipe geometries. For example, systems described herein include umbilical supply line 62 as shown in FIGS. 2-4. The umbilical supply line 62 can include and provide a plurality of different components, for example, hydraulic fluids, cameras, power supplies, air, lining materials, and other. The systems and methods described herein can provide a system that minimizes seizing or locking up of the lines as they are drawn around bends in a pipeline system. For example, in some cases, a plurality of annular spaced disks 61 can encase an umbilical supply line 62 as shown in FIGS. 2-4 and 6-7B. Further description of such aspects of the systems for maintaining a pipeline system are described in U.S. Pat. No. 10,576,489, which is incorporated by reference in its entirety, as if fully set forth in the present application.

In some cases, the systems can include systems for positioning an umbilical supply line. The systems for positioning umbilical supply lines may comprise an umbilical supply line; a plurality of spaced apart annular disk assemblies, wherein each annular disk assembly defines an aperture through which the umbilical supply line is positioned; an umbilical tether drive system comprising at least one drive element driven by a drive motor, the drive element having a plurality of protrusions; and a reeling apparatus comprising an axle that receives the umbilical supply line therearound.

In some cases, the umbilical drive system can be located on a level wind peel and can propel an unpowered centralizer tooling both into and out of a pipeline system in a highly controlled manner. Such umbilical drive system can allow positioning of the tooling to specific locations inside the pipe. In some such cases, the system can allow the centralizer tooling to return to a desired position in the pipe, for example, a position where anomalies are discovery during inspection to facilitate point repairs.

As described herein, the umbilical tether drive can provide controlled motion during the ingress and egress of the tooling in a pipe. Smooth uniform transitioning travel of the centralizer is needed for both cleaning and lining applications in a large pipe with powered tools as well as in a smaller pipe where a centralizer can be propelled via a umbilical tether drive system.

In some cases, a reeling apparatus take-up and tool drive can operate in tandem when powered centralizers are employed. In such cases, the ingress or egress speed can be synchronized between the components. In such cases, digital encoders or other sensors can be utilized to aid in such synchronization. In some cases, in the event of slippage or momentary loss of drive tire engagement between the driven centralizer and the pipe wall, the umbilical tether drive system can eliminate the loss of motion of the centralizer as the umbilical travel is obtained by the synchronized tool and reel take-up.

In some cases, upon movement of the drive element, at least one of the plurality of protrusions engage one of the spaced apart annular disk assemblies to drive movement of the umbilical supply line. In some cases, upon movement of the drive element, at least one of the plurality of protrusions engage one of a plurality of catch structures positioned on the umbilical supply line. The plurality of protrusions of the drive element can include teeth, cleats, chain links, or other structure that can engage with the umbilical supply line and/or the plurality of spaced-apart annular disk assemblies. In some cases, the spaced apart annular disk assemblies comprise a plurality of catch structures that comprise a complementary shape to the plurality of protrusions of the drive element, for example, structures having a male-female complementary relationship. In some cases, the umbilical supply line can include a plurality of catch structures positioned on, affixed to, and/or connected to the umbilical supply line.

The umbilical tether drive system further comprises a power supply and a control unit. The control unit can be in communication with the power supply and the at least one drive motor. The control unit can control at least one of the position of the umbilical supply line, the speed of the movement of the umbilical supply line, direction of movement of the umbilical supply line, and/or length or pay-out of the umbilical supply line deployed. In some cases, the umbilical tether drive system includes at least one sensor to detect at least one of position, speed, direction of movement, and/or length of the umbilical supply line deployed. The at least one sensor can transmit data to the control unit such that the control unit can process and adjust the appropriate input to adjust one of the position of the umbilical supply line, the speed of the movement of the umbilical supply line, direction of movement of the umbilical supply line, and/or length or pay-out of the umbilical supply line deployed.

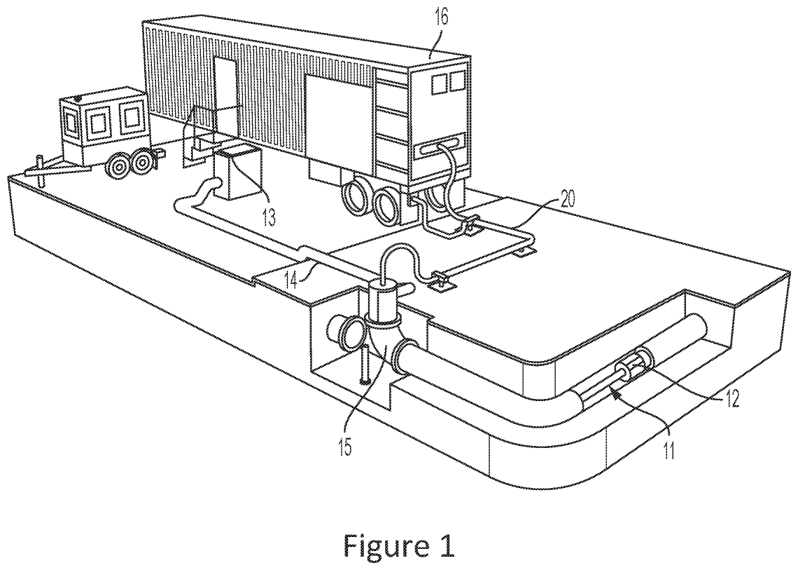

FIG. 1 shows an example of a system for maintaining a pipe system. The trailer 16 can include various equipment to assist with the maintenance of the pipe system as known to one of ordinary skill in the art, for example, reeling apparatus, controllers, materials for cleaning the pipe and other. The pipe exiting the rear of the trailer 16 enters a delivery system 20. The delivery system 20 is shown spanning a grass field. In other cases, the delivery system can be used to span across fields, cluttered construction sites, vegetation, mud, or other areas that prevent the trailer being position near the insertion point 15. The delivery system 20 can also be deployed to travel through walls, under stationary industrial equipment, fences, pipe racks, through stair wells, or other difficult terrain or structures to navigate. The delivery system can facilitate performing the maintenance of the pipe system. In some cases, the delivery system 20 can include apparatuses and systems to control the humidity and temperature within the pipe so that a centralizer does not travel through excessive moisture or other adverse conditions.

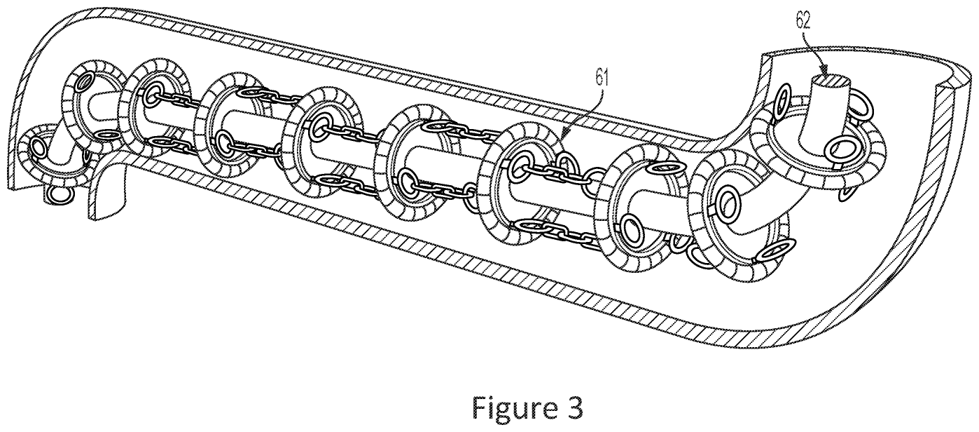

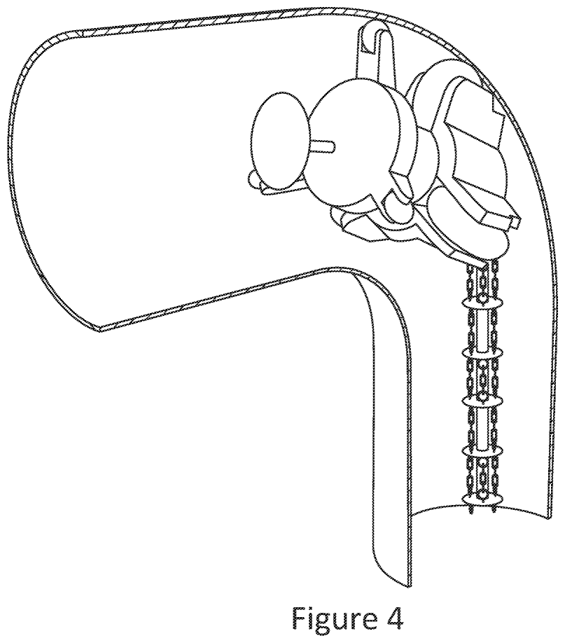

The centralizer 12 and umbilical supply line 11 are shown positioned down pipe after rounding the 90-degree elbow. A closer view of an example of the centralizer is shown at FIG. 4. Additional views of the umbilical supply line and plurality of spaced apart annular disks are shown in FIGS. 2 and 3.

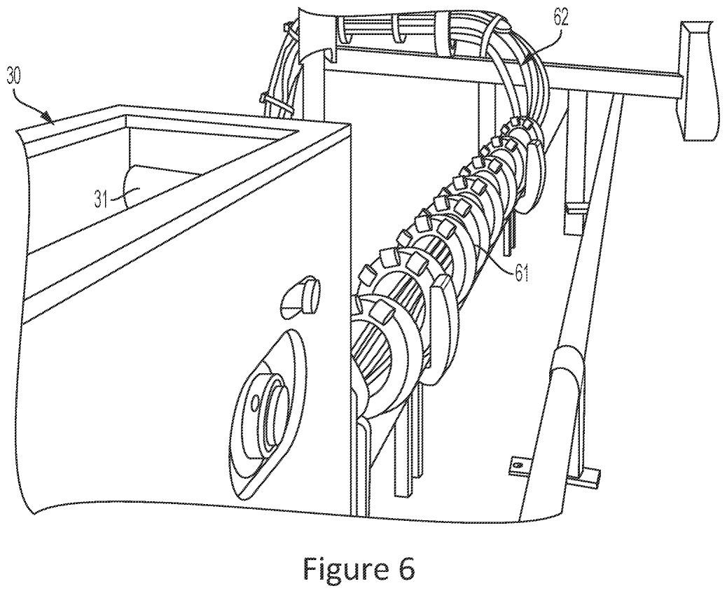

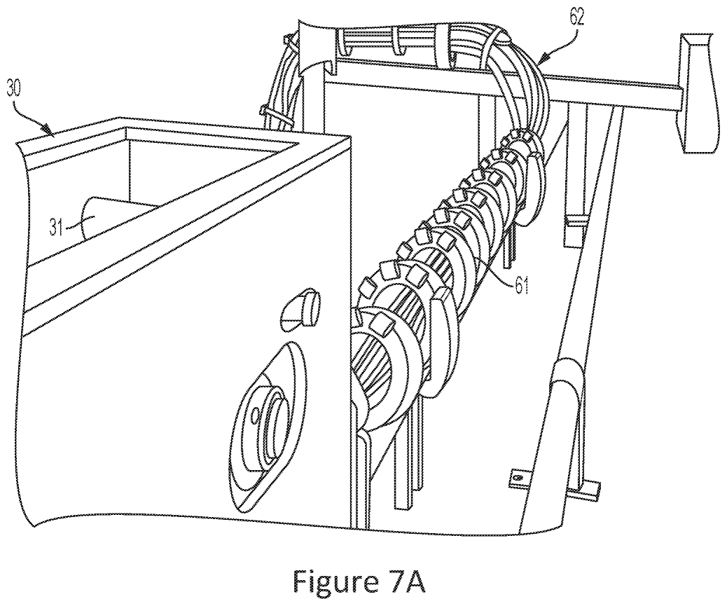

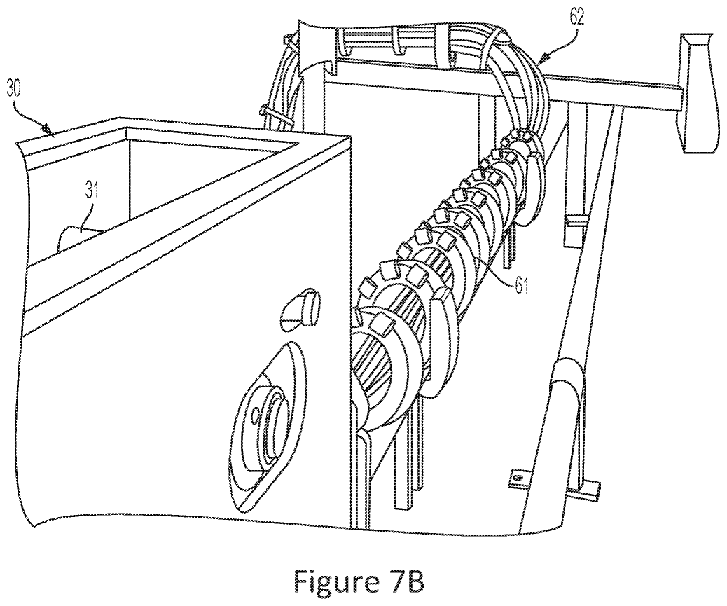

In some cases, the system shown in FIG. 1 can utilize an umbilical tether drive system like that shown in FIGS. 5-7B. As shown in FIG. 6, the umbilical tether drive system includes a drive element that includes a plurality of protrusions. One of the protrusions is shown in FIG. 6 at protrusion 31. Protrusion 31 rotates via a chain and engages the plurality of annular disk assemblies. FIG. 7A show an umbilical supply line in a first position with a part of a protrusion 31 shown in first position. As the protrusion 31 moves and in a counter clockwise direction, it contacts and engages with an annular disk assembly to move the entire umbilical supply system in a smooth and controlled manner. FIG. 7B shows the protrusion in a second position which results in motion of the umbilical supply line. The drive element comprises a plurality of protrusions that rotate in both a clockwise and counterclockwise direction such that the umbilical supply line is deployed and retracted. Other drive elements can be utilized such as teeth, protrusions, or links.

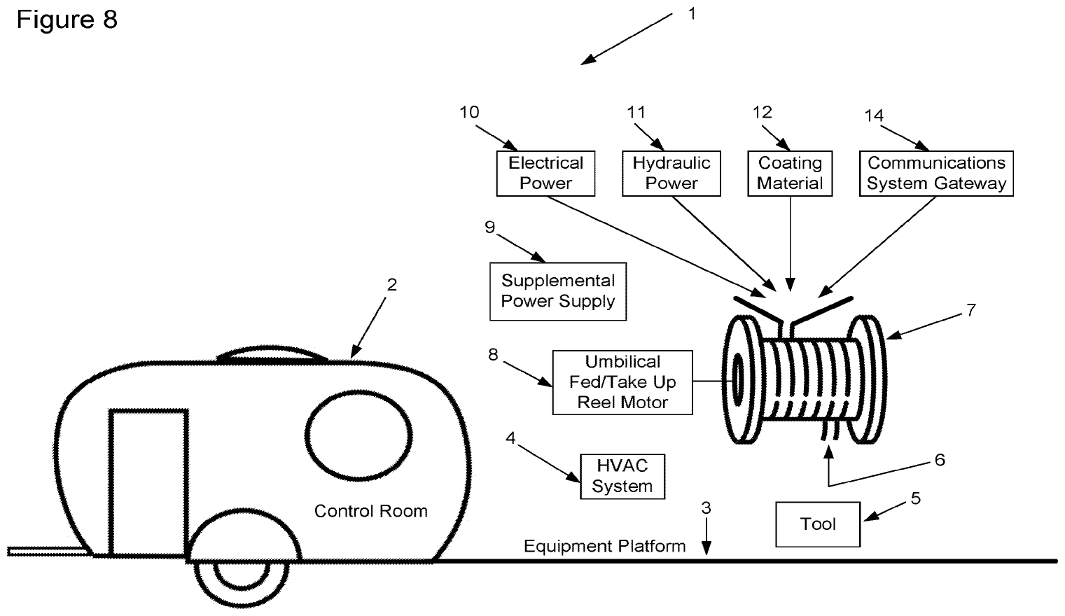

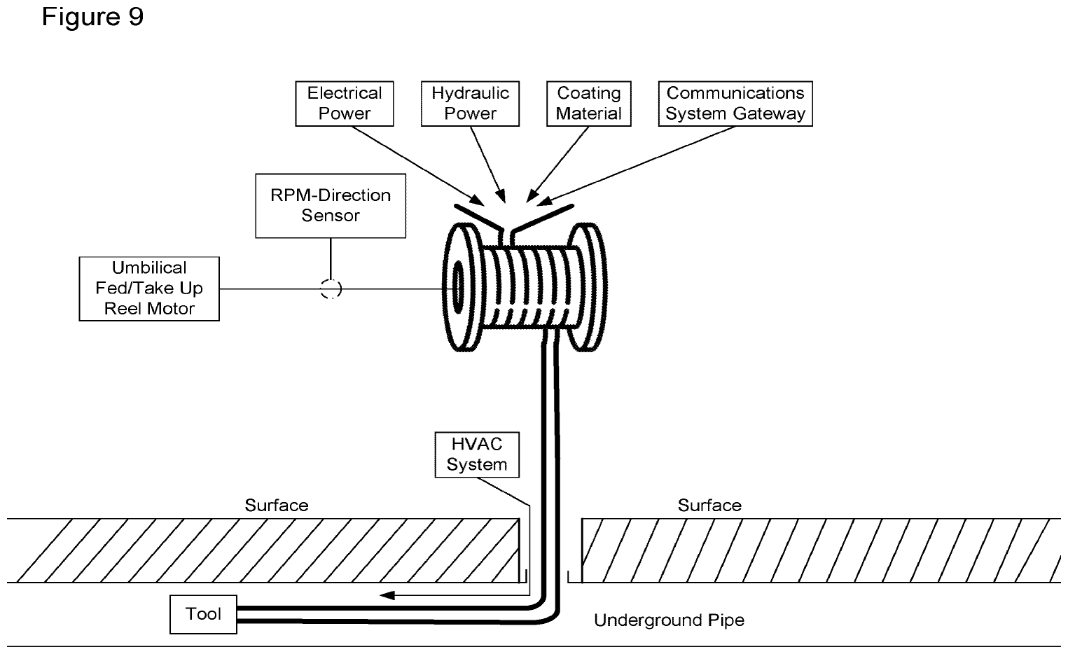

FIGS. 8 and 9 illustrate one embodiment of a system 1 for an internal wall coating distribution within conduits and pipes in a pipeline system in accordance with the present disclosure.

The system can be deployed from a mobile vehicle such as a truck or trailer 2 with an equipment platform 3, for example, like that shown in FIG. 1.

A supplemental power supply 9 is provided in order to power all of the system's components. The power can be in the form of electrical power or hydraulic power, depending on a particular component's requirements as one skilled in the art will understand.

The components of the system include tool 5 for carrying out the coating operation inside the conduit or pipe. Tool 5 has a mobility drive system which allows it to move through the pipe as necessary in order to carry out the coating operation. Tool 5 is attached to the end of an elongated umbilical 6 which is wound around reel 7. Umbilical 6 is fed from reel 7 as tool 5 progresses through the pipe by umbilical feed/take up reel motor 8 in synonymous with the tool 5 mobility drive system. Reel motor 8 cooperates in withdrawing tool 5 from the pipe as well.

In order to achieve the most efficient and even coating of the inside layer of the pipe, the atmosphere inside the pipe must be brought to and maintained at an ideal condition during the coating operation. This is achieved through HVAC System 4 which injects air into the pipe under controlled conditions. As described herein, the air conditions in the pipe can be controlled by wherein in connection with HVAC System by adjusting the temperature of the air discharged into the pipe, the humidity of the air discharged into the pipe, and/or the velocity of the air in the pipe (e.g., by adjusting the velocity of the air discharged into the pipe and/or by utilizing an orifice plate positioned in the pipe to adjust the air velocity)

Coating material 12 is delivered to tool 5 inside the pipe through a feed line in the interior of umbilical 6. Electrical power 10 and hydraulic power 11 are also fed to tool 5 through respective feed lines in the interior of umbilical 6.

A communications system gateway line 14 is also fed though umbilical 6 for purpose of collecting sensor data and providing control signals to tool 5 from a control system.

FIG. 9 illustrates the coating system of the invention where tool 5 is deployed inside an underground.

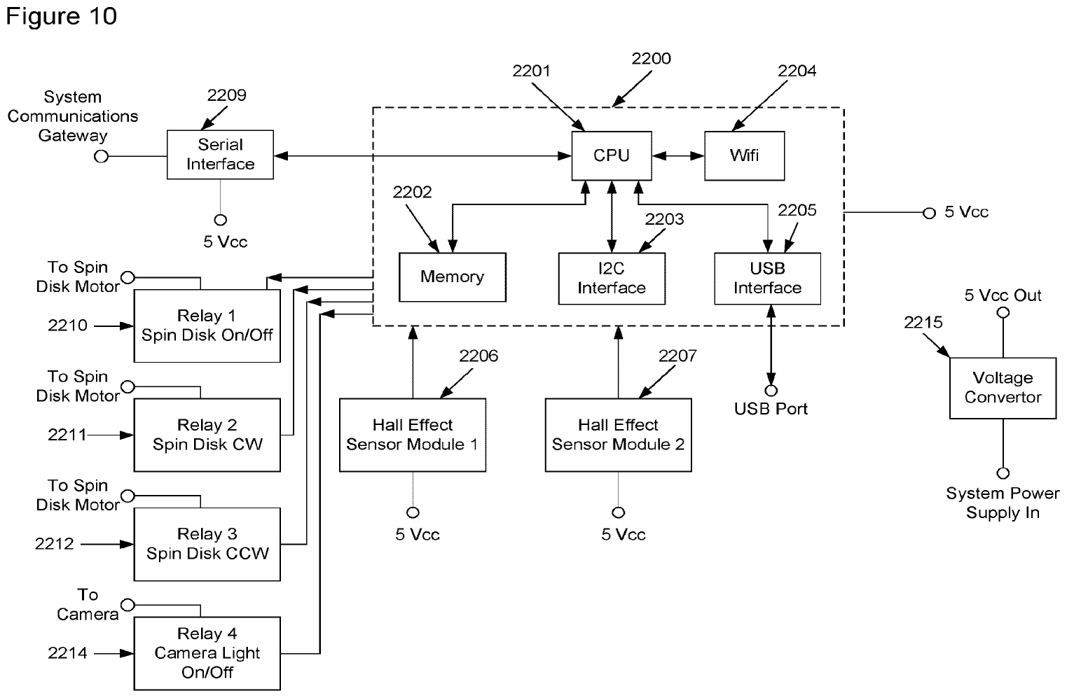

FIGS. 10-14 illustrates a control system for controlling coating system shown in FIGS. 8 and 9.

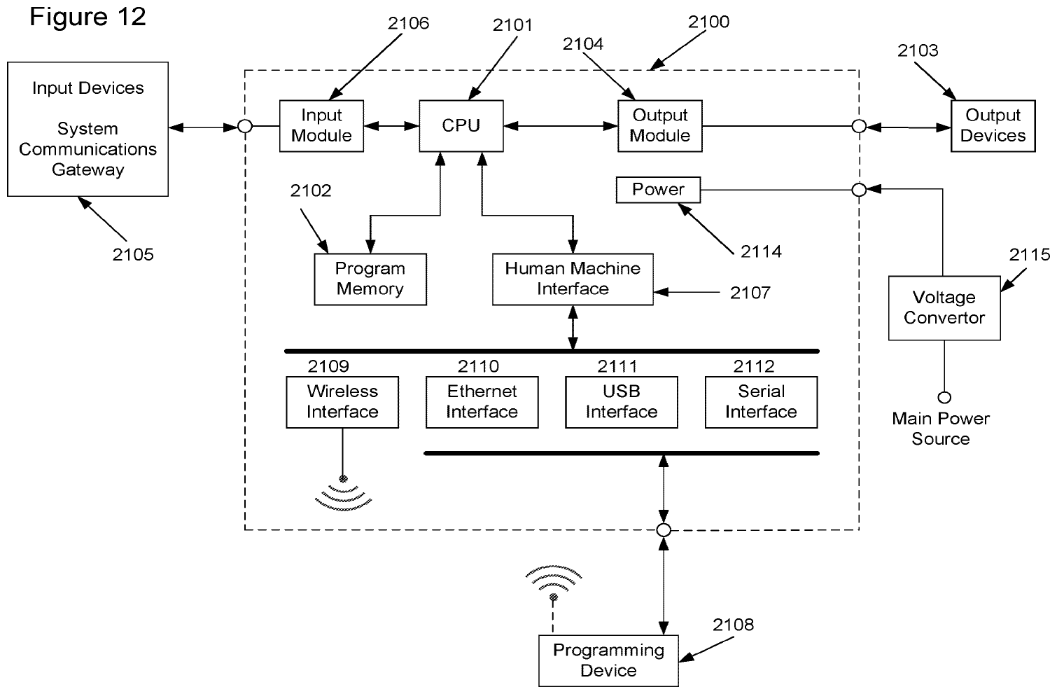

FIG. 12 is a block diagram of a programmable logic controller 2100 (PLC) which can be used to implement the control logic functions of the control system.

PLC 2100 includes a central processing unit (CPU) 2101 which executes a computer software instruction set as programmed into program memory 2102 for controlling external output devices 2103 through output module 2104.

In order to carry out its control functions, PLC 2100 receives input data from external input devices 2105 via input module 2106.

PLC 2100 also includes human machine interface (HMI) 2107 which allow the PLC to communicate with programming device 2108 for programming the PLC with the aforementioned computer software instruction set and for the purpose of obtaining diagnostic and system data.

As shown in FIG. 12, the communications path between HMI 2107 and programming device 2108 can take the form of wireless interface 2109, Ethernet interface 2110, USB interface 2111 or serial interface 2112. Each of these interfaces can be implemented as one of ordinary skill in the art would understand.

Internal power 2114 for the PLC can be provided by an external power supply implemented by voltage convertor 2115. Convertor 2115 is itself powered by the main power source that powers the machinery which the PLC controls. Convertor 2115 converts the main power source voltage as needed to provide electrical power to the PLC.

As mentioned above, input module 2106 received input data from input devices 2105. The inputs devices which provide this data are illustrated in FIGS. 9-14.

FIG. 10 depicts a microcontroller unit 2200. The microcontroller unit includes a central processing unit (CPU) 2201 which executes a computer software instruction set as programmed into memory 2202.

Coupled to CPU 2201 is an I2C interface 2203 which implements an inter-integrated circuit (I2C) protocol as is known in the art and a USB Interface 2205 as also known in the art. I2C 2203 allows data to be passed to CPU 2201 from Hall effect sensor modules 2206 and 2207 which measures the rotational speed of the aforementioned disk.

Electrical power is suppled to microcontroller unit 2200 by an external power supply in the form of voltage convertor 2215. Convertor 2215 derives its power from the main power source that powers the machinery which PLC 2100 (FIG. 12) controls. Convertor 2215 converts the main power source voltage as needed to provide electrical power to microcontroller unit 2200.

The RPM data collected by microcontroller 2201 from Hall Effect sensor modules 2206 and 2207 is sent to serial interface 2209 which forwards the data to the system communications gateway. The communications gateway is the primary communications path to which all of the system sensors and control devices ultimately connect, including input module 2106 of PLC 2100 via input devices 2105.

The disk rotational data from Hall Effect sensor modules 2206 and 2207 is processed by PLC 2110 and in accordance with that process, PLC 2110 sends control signals for the drive motor of the disk back to microcontroller unit 2200. The returned data triggers microcontroller unit 2200 to control relay 2210 to turn the disk motor on or off; control relay 2211 to cause the drive motor to spin the disk in a clockwise direction; and control relay 2212 to cause the drive motor to spin the disk in a counter-clockwise.

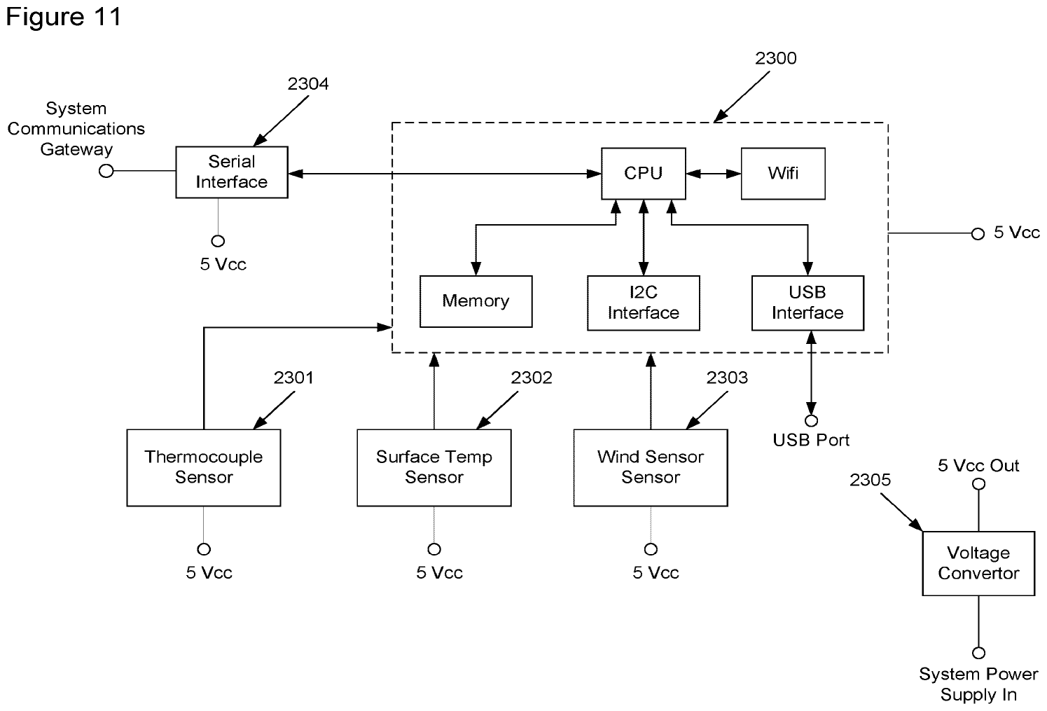

In many cases the machinery operating inside the pipe will have an inspection or observation camera and a lighting system to illuminate the areas under inspection or observation. PLC 2100 can also send control signals to microcontroller unit 2200 to control relay 2214 for the purpose of turning the lighting system on and off. FIG. 11 depicts a microcontroller unit 2300 which has the same architecture and includes the same components as described with respect to microcontroller unit 2200. This microcontroller captures data from thermocouple sensor 2301 for measuring head temperature of the spinning disk; surface temperature sensor 2302 for measuring the temperature of the pipe wall to which the spinning disk is applying material; and wind sensor 2303 for measuring the spend of air movement in the work area inside the pipe.

The data collected by microcontroller 2300 from thermocouple sensor 2301, surface temperature sensor 2302 and wind sensor 2303 is sent to serial interface 2304 which forwards the data to the system communications gateway. PLC 2100 retrieves the data from the gateway via input devices 2105 and input module 2106.

Electrical power is suppled to microcontroller unit 2300 by an external power supply in the form of voltage convertor 2305. Converter 2305 derives its power from the main power source that powers the machinery which PLC 2100 (FIG. 12) controls. Convertor 2305 converts the main power source voltage as needed to provide electrical power to microcontroller unit 2300.

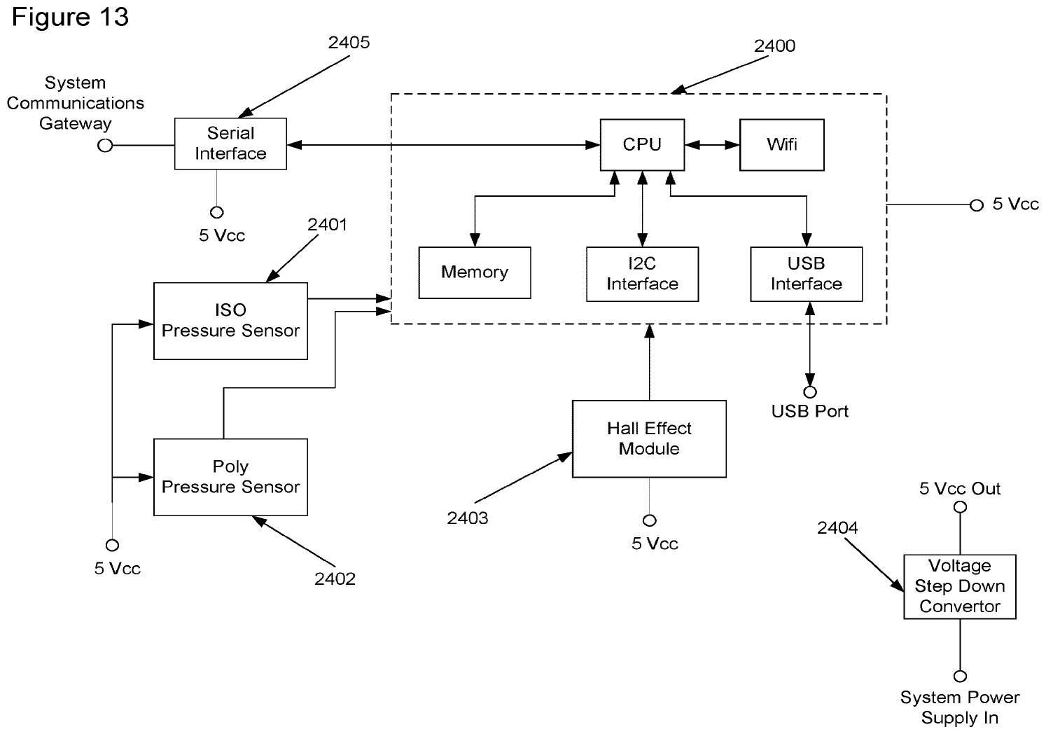

FIG. 13 depicts a microcontroller unit 2400 which has the same architecture and includes the same components as described with respect to microcontroller unit 2200. This microcontroller captures data from ISO pressure sensor 2401, poly pressure sensor 2402 and Hall Sensor effect module 2403.

This data is sent to serial interface 2405 which forwards the data to the system communications gateway. PLC 2100 retrieves the data from gateway via input devices 2105 and input module 2106.

Electrical power is suppled microcontroller unit 2400 by an external power supply in the form of voltage convertor 2404. Converter 2404 derives its power from the main power source that powers the machinery which PLC 2100 (FIG. 12) controls. Convertor 2305 converts the main power source voltage as needed to provide electrical power to microcontroller unit 2400.

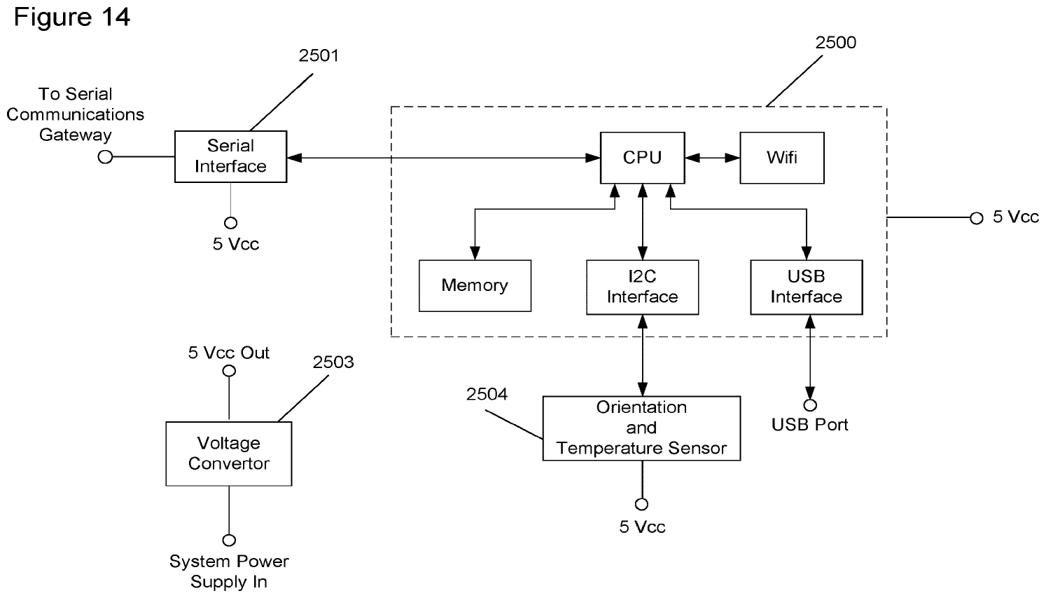

FIG. 14 depicts a microcontroller unit 2500 which has the same architecture and includes the same components as described with respect to microcontroller unit 2200. This microcontroller captures data from orientation and temperature sensor 2504.

This data is sent to serial interface 2401 which forwards the data to the system communications gateway. PLC 2100 retrieves the data from gateway via input devices 2105 and input module 2106.

Electrical power is suppled to microcontroller unit 2500 by an external power supply in the form of voltage convertor 2503. Converter 2503 derives its power from the main power source that powers the machinery which PLC 2100 (FIG. 12) controls. Convertor 2503 converts the main power source voltage as needed to provide electrical power to microcontroller unit 2500.

With reference again to FIG. 12, programming device 2108 can be a desk top computer, laptop, notebook or similar computing device.

In addition to programming, Human Machine Interface 2107 allows a computing device running a corresponding software app to remotely communicate with PLC 2100 in in real or near real-time. This allows a system operator and/or other stakeholders to constantly monitor the operation of the symptom remotely.

As shown in FIG. 12, PLC 2100 can be connected to the Internet wireless via wireless interface 2109, Ethernet interface 2110, USB interface 2111 or serial interface 2112. The particular interface to be used will depend on bandwidth needed to accommodate the degree of monitoring required by the operator or stakeholder.

In some cases, the systems described herein can include a system for controlling temperature and humidity conditions in a pipe. The system may comprise an air conditioning apparatus configured to discharge air into a pipe; at least one sensor configured to detect at least one of temperature, air velocity, and/or position of a centralizer; and a control unit configured to adjust the air conditions in the pipe based on the data from the at least one sensor. In some cases, the control unit is configured to adjust at least one of the temperature of the air discharged into the pipe, the humidity of the air discharged into the pipe, and/or the velocity of the air discharged into the pipe. In some cases, the control unit is configured to adjust the air velocity in the pipe by controlling the dimension of an orifice positioned in the pipe.

In some cases, the systems can control the conditions at the position of the sprayer. In some cases, the at least one sensor is positioned in proximity to the centralizer. In some such cases, the at least one sensor is positioned near the spin disk. The at least one sensor can detect different conditions close in proximity to the point in which the lining material is applied to the interior of the pipe. Such conditions, e.g., the temperature, air velocity, and/or humidity, can impact the application of the lining material to pipe. For example, as cleaning and lining are often performed as the centralizer is retracted from its starting point while reversing to the point of entry, the air velocity closest to the point of entry can be greater that for example, some 100 feet down the pipe line. Air flow velocity can be reduced as the tool approaches the insertion point to minimize disruption of the coating deposition zone. The sensor can detect air flow velocity throughout the retraction process, communicate such data to the control unit, which can control and adjust the air conditioner to increase or decrease the air flow being introduced by the air conditioner system. An example of such an air conditioner is shown in FIG. 1 as air conditioner 13, which is connected to the pipe through duct 14. The air conditioner can provide air to cool and/or heat the conditions inside the pipe and/or can adjust the humidity inside the pipe.

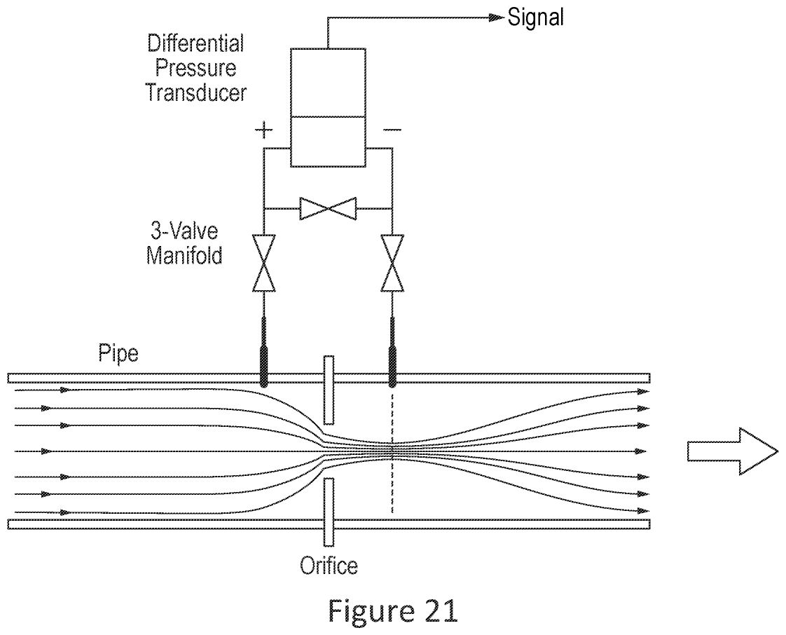

In some cases, the system can control the air velocity within the pipe via a structure that defines an orifice through which air flows. The structure can be an orifice plate or restrictive plate. As air flows toward the orifice plate upstream of the orifice, the orifice forces the air to converge and pass through the orifice. FIG. 21 shows an example of such a structure. In some cases, the structure can adjust the dimension of the orifice, e.g., the increase or decrease the diameter of the orifice or adjust the shape of the orifice (full circle to partial circle), to modify and/or produce a desired air flow velocity in the pipe. In some cases, the orifice has a circular dimension. In some cases, the orifice has a non-circular dimension. In some systems, an orifice plate may define a plurality of orifices to adjust the air flow velocity in the pipe. FIG. 21 shows an example that includes a differential pressure transducer that can be used to detect air flow (via pressure differential) such that it transmits a signal to a control unit. The control unit upon receiving the signal can adjust the air flow and/or orifice dimension to produce a desired air flow velocity at downstream location.

In some cases, the system can control the air velocity within the pipe by changing the speed of the motor or fan. The system can modify the air velocity in the pipe through a combination of the changing the speed of the motor and use of an orifice.

Many conventional pipe maintenance systems can supply set temperature conditions to a pipe system during a lining application; however, many such systems introduce air flow having a set temperature, humidity, and/or air velocity and do not adjust such conditions based on internal pipe conditions at the centralizer. The systems described herein can provide synchronized condition control of each tool via board acquisition modules like those described herein.

As used herein, unless otherwise expressly specified, all numbers such as those expressing values, ranges, amounts or percentages may be read as if prefaced by the word “about”, even if the term does not expressly appear. Any numerical range recited herein is intended to include all subranges subsumed therein. When ranges are given, any endpoints of those ranges and/or numbers within those ranges can be combined with the scope of the present disclosure. Plural encompasses singular and vice versa. When ranges are given, any endpoints of those ranges and/or numbers within those ranges can be combined within the scope of the present disclosure. Including and like terms means “including but not limited to”. The word “comprising” and forms of the word “comprising” as used in this description and in the claims does not limit the disclosure claimed to exclude any variants or additions.

As used herein, the terms “on”, “applied on/over”, mean formed or provided on but not necessarily in contact with the surface. Each of the characteristics and examples described above and below, and combinations thereof, may be said to be encompassed by the present disclosure.

As used herein, the meaning of “a,” “an,” and “the” includes singular and plural references unless the context clearly dictates otherwise.

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below. The terms “comprising.” “having,” “including,” and “containing” are to be construed as open-ended terms (i.e., meaning “including, but not limited to”) unless otherwise noted.

Although the disclosure has been described in terms of “comprising”, “consisting essentially of” or “consisting of” are also within the scope of the present disclosure. In this context, “consisting essentially of” means that any additional components will not materially affect the viscosity, dry time, and/or scrub resistance of the composition.

While this specification describes the systems being deployed in a pipe or conduit positioned in the ground, a person of ordinary skill in the art would understand that the system can be applied to other structures. Some non-limiting examples of structures include joints between two wall structures, within a floor structure, or on a roof structure, or partially within such structures. The systems described herein can also be used in pipes or conduit exposed to ambient conditions, e.g., uncovered and not otherwise within a structure.

The disclosure will be further described by reference to the following examples.

### EXAMPLES

Notwithstanding that the numerical ranges and parameters setting forth the broad scope of the disclosure are approximations, numerical values set forth in the specific examples are reported as precisely as possible. Any numerical value, however, inherently contains certain errors necessarily resulting from the standard variation found in their respective testing measurements.

### Example 1

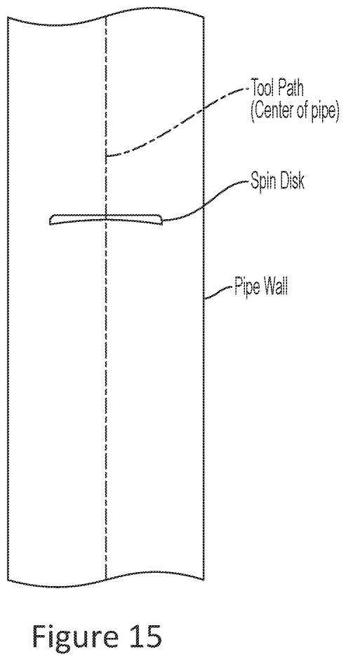

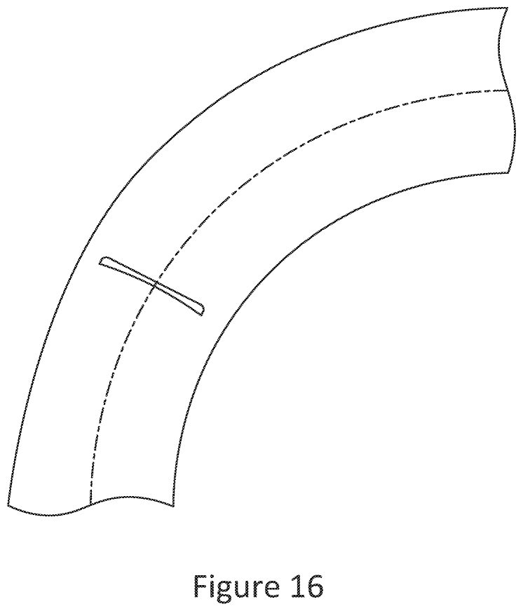

As described above, in some cases, the system can be utilized in a pipe system having 90 degree corners and being used for applying a lining to the interior of the pipe. For example, as the spin disk travels through the pipe, it can apply a coating to the side wall. While the pipeline follows a straight path, the coating is applied uniformly against the wall, as the velocity is uniform around spin disk relative to the wall. As the disk travels around a wall however, the disk leaves the center of the path due to the length required of the tool. In some cases, the tool or centralizer can have a minimal length of 35 inches long for a 30 inch pipe without the attached spin disk. In some cases, the maximum length of the entire tool including a spin disk is 45 inches. The maximum straight length of the tool through the curve of the pipe calculated as the diameter of the pipe multiplied by a factor of 1.5. As the tool moves along the path, the disk is centered along the path of the of the pipe as shown in FIG. 15. On curved pipes however, due to the length of the tool, the disk is no longer centered on the path but rather is offset in a manner similar to that shown in FIG. 16. As can be seen in FIG. 16, as the tool goes around the curve, one side will be coated more than the other as the tool travels through. In some cases, the goal for coverage of a coating is no more than a 15% difference in the coating thickness between two sides of the curve.

Two methods of analyzing the maximum length can be employed. The first measures the distance of offset of each side of the disk as it travels along the path in a simulated pipe and checking the offset ratio (Method 1). The second method examines the angular velocities of the edges of the disk relative to their respective walls (Method 2).

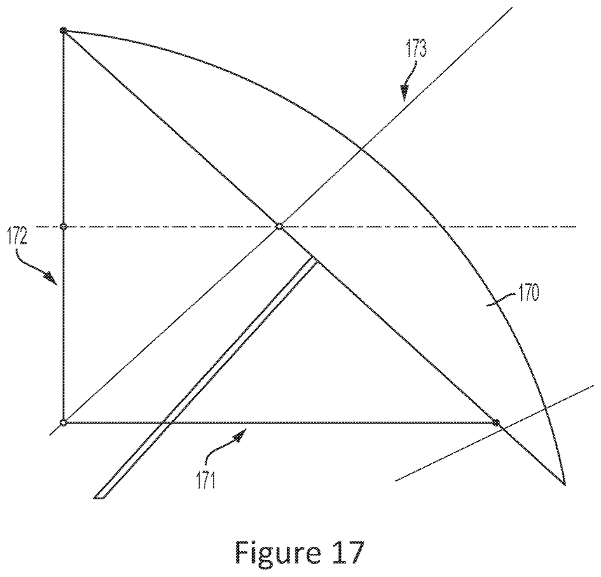

Table 1 shows the measured data at different points from a SolidWorks model. Table 1 measures the distance of the edge of the disk 170 to the center path 173, all distances being in inches. Using this data, the two methods of analysis will be shown below. FIG. 17 shows a diagram on how measurements were taken to calculate the data in Table 1, the x-axis being labeled 171, the y-axis being 172, and the center path being 173. The measurements based on the x coordinate and y coordinate are used to calculate the real measurement (or the hypotenuse).

TABLE 1

| Overall | | | | | | |
|---|---|---|---|---|---|---|
| length | x over | y over | Over | x under | y under | Under |
| 36 | 3.7375 | 3.3032 | 4.987989 | 3.0099 | 2.6562 | 4.014336 |
| 37 | 3.9136 | 3.4765 | 5.234722 | 2.8183 | 2.4813 | 3.754952 |
| 38 | 4.125 | 3.617 | 5.486193 | 2.312 | 2.5814 | 3.465396 |
| 39 | 4.3438 | 3.7828 | 5.76005 | 2.3824 | 2.1491 | 3.208498 |
| 40 | 4.5559 | 4.0033 | 6.064869 | 2.2097 | 1.9176 | 2.925742 |
| 40.5 | 4.667 | 4.1193 | 6.224911 | 2.0752 | 1.8536 | 2.782497 |
| 40.625 | 4.7018 | 4.1344 | 6.261005 | 2.0104 | 1.7846 | 2.688216 |

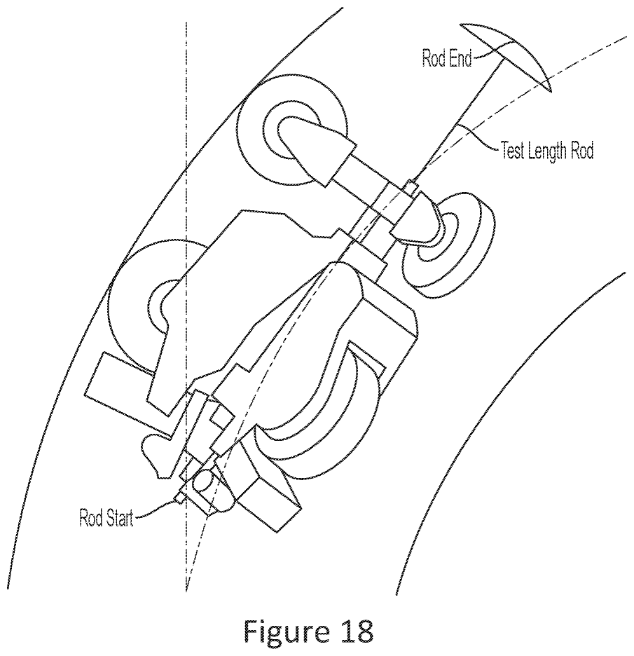

The test was simulated by placing a rod in the model which could be adjusted for various lengths (see FIG. 18). The measurements were taken with the tool spaced about 50% inside the curve as this would be the area in which the tool would be the furthest off-center axis.

### Method 1 of Example 1 Based on the Ratio Disk Offset.

Using a proposed ratio of 3:7 to get the tool to coat the outside wall at the same rate as the inside wall, the corresponding ratio of a 9 inch diameter disk, to get the same ratio is 2.7:6.3. These two ratios, when converted to decimals gives 0.42857. Based on this method, for a 9 inch disk as it passes a short 90 elbow, the 2.7 inches of the disk is on one side and 6.3 inches of the disk is on the other. Comparing this to the measured data in Table 1, the ideal length occurred at 40.625 inches.

### Method 2 of Example 1 Based on the Angular Velocities

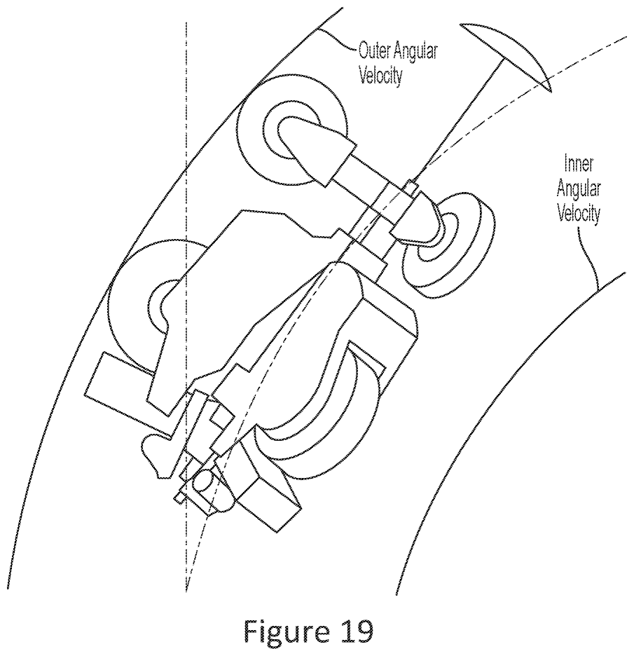

Method 2 looks at the angular velocity of the outside wall to the closest edge of disk, similarly, the inside wall velocity relative to its edge of the disk, FIG. 19 shows this measurement. The analysis can determine how fast the outer wall moves relative to the disk and similarly the inside wall to the edge of the disk. The first step was to determine the middle path which was, for a 30 inch pipe, 60 inches. The tool velocity, from a predicted constant speed of 9 ft/min or 108 in/min. The formula for angular velocity is shown below.

$$ω = \frac{{V}_{max}}{radi u s}$$

The outer and inner wall will remain at constant velocity whereas the tool will be variable based on the length of how far the spin disk is located. When comparing the data, conceptually, the ratio of velocity from disk edge to inner/outer wall, should be as low as possible. This follows that no more than a 15% difference in coating thickness while progressing through the elbow. The ratio can be calculated as follows:

$${ω}_{1} = \frac{{V}_{max}}{{Radius}_{Outerwall}}$$

$${ω}_{2} = \frac{{V}_{max}}{{Radius}_{Innerwall}}$$

$${ω}_{3} = \frac{{V}_{max}}{{Radius}_{OuterDisk}}$$

$${ω}_{4} = \frac{{V}_{max}}{{Radius}_{InnerDisk}}$$

$${η}_{1} = \frac{{ω}_{3}}{{ω}_{1}}$$

$$η = \frac{{ω}_{2}}{{ω}_{4}}$$

The ratios of η₁ & η₂ are the differences in of the outer/inner wall to the edge of the disk. The radius of the outer/inner disk is calculated by the center radius±the disk offset. The outer disk offset is added to the radius whereas the inner disk radius is subtracted from the center radius. Example: center radius is 60 inches, outer disk is 6.3 inches lower disk is 2.7 inches, the inner would 60−2.7 and the outer would be 60+6.3. Once the two ratios are calculated, the comparison comes from taking the percent difference between the two. Using this analysis, at 41 inches, using the same measurement system as before, the percent difference between the two is only 8.4%. This 8.4% difference can then be inferred for falling within the constraints of 15% coating difference based on the theoretical model.

### Mathematical Formulation

For any path which involves a 90 elbow, the path can follow one of two equations. Standard 90 elbow:

$$f ( x , y ) = \{ \begin{matrix}x = 0 & y < 0 \\ \sqrt{{r}^{2} - {( x - r )}^{2}} & x < r \\ x = r & x \geq r\end{matrix}$$

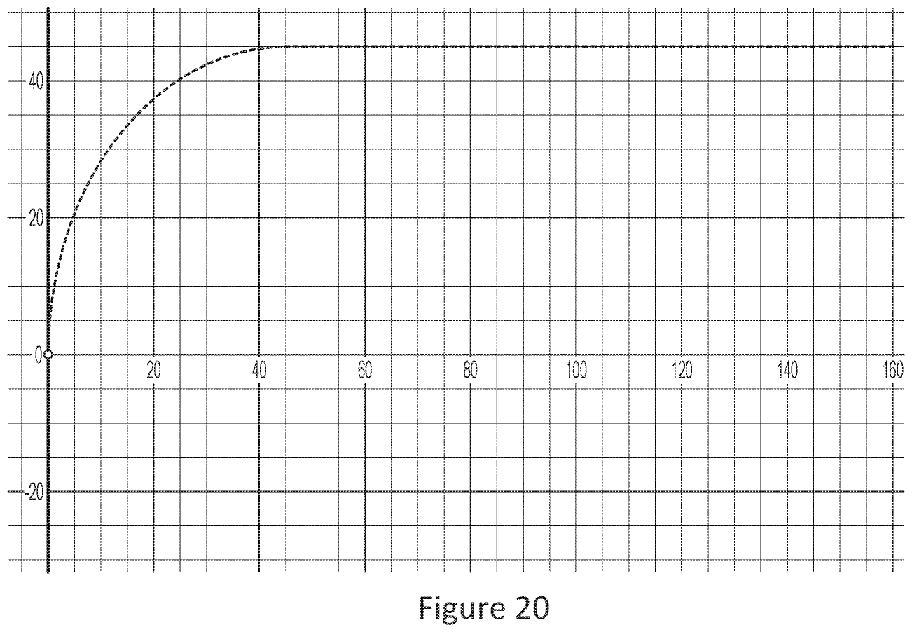

This formula dictates the path a tool will take based on the radius of the pipe. It will be true for all pipes based on the minimum bend radius r. Standard minimum bend radius rules follow a 1.5*Diameter rule. For example, if a pipe is 30″ in diameter, it has a minimum bend radius of 45″. Example shown below for a pipe 30″ in diameter with its graph shown at FIG. 20.

$$f ( x , y ) = \{ \begin{matrix}x = 0 & y < 0 \\ \sqrt{{45}^{2} - {( x - 45 )}^{2}} & x < 45 \\ x = 45 & x \geq 45\end{matrix}$$

Using this method, the maximum length of a straight piece at any given point along the curve cannot exceed the maximum bend radius. If the max length exceeds minimum bend radius, tool will collide with wall and cannot make the turn. As each centralizer will likely be different dimensions for each particular pipe, the overall length can change.

The above calculations can be used to calculate the tool length. Based on the modeled data, the ideal length for the tool's overall length must follow the following equality: 1.3125*D<Tool Length<1.37*D, with “D” being the diameter of the pipe. The length is measured from bottom of the tool, to top of spin disk. So long as this follows standard 90 elbows & miter joints of 1.5*D and greater than 3 bends, then the tool should be able to traverse the path while keeping the spin disk inside the parameters given at the start.

For the 30 inch pipe, the ideal location for the top of the spin disk, relative to the end of the centralizer, was between 40.625 inch and 41 inch depending on which method of analysis is shown to be more accurate. This allows for the spray head, and centralizer shield to be in position. In measuring a sample lining centralizer in the shop, the existing design had the spin disk approximately 2 inch closer to the unit. Based on this model, the two units, physical and SolidWorks Model are relatively the same from a mathematical standpoint that can be used to fit the ideal location of the tool for any size pipe.

### Illustrative Embodiments of Suitable Systems

As used below, any reference to methods, products, or systems is understood as a reference to each of those methods, products, or systems disjunctively (e.g., “Illustrative embodiment 1-4 is understood as illustrative embodiment 1, 2, 3, or 4.”).

Illustrative embodiment 1 is a system for positioning an umbilical supply line, the system comprising an umbilical supply line; a plurality of spaced apart annular disk assemblies, wherein each annular disk assembly defines an aperture through which the umbilical supply line is positioned; an umbilical tether drive system comprising at least one drive element driven by a drive motor, the drive element having a plurality of protrusions; and a reeling apparatus comprising an axle that receives the umbilical supply line therearound.

Illustrative embodiment 2 is a system of any preceding or subsequent illustrative embodiment wherein upon movement of the drive element, at least one of the plurality of protrusions engage one of the spaced apart annular disk assemblies to drive movement of the umbilical supply line.

Illustrative embodiment 3 is a system of any preceding or subsequent illustrative embodiment wherein upon movement of the drive element, at least one of the plurality of protrusions engage one of a plurality of catch structures positioned on the umbilical supply line.

Illustrative embodiment 4 is a system of any preceding or subsequent illustrative embodiment wherein the umbilical tether drive system further comprises a power supply; and a control unit that communicates with the power supply and at least one drive motor.

Illustrative embodiment 5 is a system of any preceding or subsequent illustrative embodiment wherein the umbilical tether drive system further comprises at least one sensor that detects at least one of a position of the umbilical supply line, speed of movement of the umbilical supply line, direction of movement of the umbilical supply line, and/or length of the umbilical supply line deployed.

Illustrative embodiment 6 is a system of any preceding or subsequent illustrative embodiment wherein the control unit receives data from the at least one sensor, and wherein the control unit controls the power supply to direct the operation of the drive system at least in part based on the data received from the at least one sensor.

Illustrative embodiment 7 is a system of any preceding or subsequent illustrative embodiment wherein the control unit receives data from the at least one sensor that indicates the position of the umbilical supply line such that the control unit is configured to control the drive system to position the umbilical supply line at a specific position based on the data indicating the position of the umbilical supply line in a second deployment.

Illustrative embodiment 8 is a system of any preceding or subsequent illustrative embodiment wherein the system further comprises a centralizer.

Illustrative embodiment 9 is a system of any preceding or subsequent illustrative embodiment wherein the centralizer includes a second power supply.

Illustrative embodiment 10 is a system of any preceding or subsequent illustrative embodiment wherein the centralizer does not include a separate power source.

Illustrative embodiment 11 is a system of any preceding or subsequent illustrative embodiment wherein the centralizer includes at least one drive roller and at least one spin disk.

Illustrative embodiment 12 is a system of any preceding or subsequent illustrative embodiment wherein the centralizer further comprises an application device, such as a sprayer or nozzle, for dispensing a fluid.

Illustrative embodiment 13 is a system of any preceding or subsequent illustrative embodiment wherein the system further comprises a second control unit configured to control the movement of the centralizer.

Illustrative embodiment 14 is a system of any preceding or subsequent illustrative embodiment wherein the control unit of the drive system and the second control unit are configured to synchronize deployment and retraction of the umbilical supply line and the centralizer.

Illustrative embodiment 15 is a system of any preceding or subsequent illustrative embodiment wherein the plurality of spaced apart annular disk assemblies further comprise a plurality of angularly spaced rollers mounted generally on and extending radially therefrom an outer perimeter of each of the annular disk assemblies.

Illustrative embodiment 16 is a system of any preceding or subsequent illustrative embodiment wherein the plurality of spaced apart annular disk assemblies are positioned along the length of the umbilical supply line.

Illustrative embodiment 17 is a system of any preceding or subsequent illustrative embodiment wherein the system further comprises a plurality of flexible interconnected links that couple two adjacent annular disk assemblies.

Illustrative embodiment 18 is a system of any preceding or subsequent illustrative embodiment wherein the reeling apparatus is configured to rotate such that when the reeling apparatus is rotated in a first direction, the umbilical supply line is unwound during deploying of the umbilical supply line and when the reeling apparatus is rotated in a second direction, the umbilical supply is positioned around the reel during retracting of the umbilical supply line.

Illustrative embodiment 19 is a system of any preceding or subsequent illustrative embodiment wherein the system positions the umbilical supply line in a pipe.

Illustrative embodiment 20 is a system for positioning an umbilical supply line, the system comprising an umbilical supply line comprising a plurality of catch structures positioned on, affixed to, and/or connected to the umbilical supply line; an umbilical tether drive system comprising at least one drive element driven by a drive motor, the drive element having a plurality of protrusions, wherein each of the plurality of protrusions comprise a complementary shape to the plurality of catch structures positioned on, affixed to, and/or connected to the umbilical supply line; and a reeling apparatus comprising an axle that receives the umbilical supply line therearound, wherein upon the drive motor driving the at least one drive element, the umbilical tether drive system deploys and/or retracts the umbilical supply line from the reeling apparatus.

Illustrative embodiment 21 is a system for controlling temperature and humidity conditions in a pipe, the system comprising: an air conditioning apparatus configured to discharge air into a pipe; at least one sensor configured to detect at least one of temperature, air velocity, and/or position of a centralizer; and a control unit configured to adjust the air conditions in the pipe based on the data from the at least one sensor.

Illustrative embodiment 22 is a system of any preceding or subsequent illustrative embodiment wherein the system comprises an air conditioning apparatus configured to discharge air into a pipe; at least one sensor configured to detect at least one of temperature, air velocity, and/or position of a centralizer; and a control unit configured to adjust the air discharged into the pipe tunnel based on the data from the at least one sensor.

Illustrative embodiment 23 is a system of any preceding or subsequent illustrative embodiment wherein the control unit is configured to adjust at least one of the temperature of the air discharged into the pipe, the humidity of the air discharged into the pipe, and/or the velocity of the air discharged into the pipe.

Illustrative embodiment 24 is a system of any preceding or subsequent illustrative embodiment wherein an orifice plate is deployed in the pipe to control air velocity in the pipe.

Illustrative embodiment 25 is a system of any preceding or subsequent illustrative embodiment wherein the control unit is configured to adjust the air velocity in the pipe by controlling the dimension of an orifice positioned in the pipe.

Illustrative embodiment 26 is a system of any preceding or subsequent illustrative embodiment where further including an air conditioning apparatus configured to discharge air into a pipe; a second sensor configured to detect at least one of temperature, air velocity, and/or position of a centralizer in a pipe; and a second control unit configured to adjust air conditions in the pipe based on the data from the second sensor.

Whereas various examples of the disclosure have been described in fulfillment of the various objectives of the disclosure, it should be recognized that these examples are merely illustrative of the principles of the present disclosure. Numerous modifications and adaptations thereof will be readily apparent to those skilled in the art without departing from the spirit and scope of the present disclosure as defined in the following claims.

1. A system for positioning an umbilical supply line, the system comprising
an umbilical supply line;
a plurality of spaced apart annular disk assemblies, wherein each annular disk assembly defines an aperture through which the umbilical supply line is positioned;
an umbilical tether drive system comprising at least one drive element driven by a drive motor, the drive element having a plurality of protrusions; and
a reeling apparatus comprising an axle that receives the umbilical supply line therearound.

2. The system of claim 1, wherein upon movement of the drive element, at least one of the plurality of protrusions engage one of the spaced apart annular disk assemblies to drive movement of the umbilical supply line.

3. The system of claim 1, wherein upon movement of the drive element, at least one of the plurality of protrusions engage one of a plurality of catch structures positioned on the umbilical supply line.

4. The system of claim 1, wherein the umbilical tether drive system further comprises
a power supply; and
a control unit that communicates with the power supply and at least one drive motor.

5. The system of claim 1, wherein the umbilical tether drive system further comprises at least one sensor that detects at least one of a position of the umbilical supply line, speed of movement of the umbilical supply line, direction of movement of the umbilical supply line, and/or length of the umbilical supply line deployed.

6. The system of claim 5, wherein the control unit receives data from the at least one sensor, and wherein the control unit controls the power supply to direct the operation of the drive system at least in part based on the data received from the at least one sensor.

7. The system of claim 5, wherein the control unit receives data from the at least one sensor that indicates the position of the umbilical supply line such that the control unit is configured to control the drive system to position the umbilical supply line at a specific position based on the data indicating the position of the umbilical supply line in a second deployment.

8. The system of claim 1, further comprising
an air conditioning apparatus configured to discharge air into a pipe;
a second sensor configured to detect at least one of temperature, air velocity, and/or position of a centralizer in a pipe; and
a second control unit configured to adjust air conditions in the pipe based on the data from the second sensor.

9. The system of claim 1, further comprising a centralizer.

10. The system of claim 9, wherein the centralizer includes a second power supply.

11. The system of claim 9, wherein the centralizer includes at least one drive roller and at least one spin disk.

12. The system of claim 9, wherein the centralizer further comprises an application device for dispensing a fluid.

13. The system of claim 9, further comprising a third control unit configured to control the movement of the centralizer.

14. The system of claim 13, wherein the control unit of the drive system and the third control unit are configured to synchronize deployment and retraction of the umbilical supply line and the centralizer.

15. The system of claim 1, wherein the plurality of spaced apart annular disk assemblies further comprise a plurality of angularly spaced rollers mounted generally on and extending radially therefrom an outer perimeter of each of the annular disk assemblies.

16. The system of claim 1, wherein the plurality of spaced apart annular disk assemblies are positioned along the length of the umbilical supply line.

17. The system of claim 1, further comprising a plurality of flexible interconnected links that couple two adjacent annular disk assemblies.

18. The system of claim 1, wherein the reeling apparatus is configured to rotate such that when the reeling apparatus is rotated in a first direction, the umbilical supply line is unwound during deploying of the umbilical supply line and when the reeling apparatus is rotated in a second direction, the umbilical supply is positioned around the reel during retracting of the umbilical supply line.

19. The system of claim 1, wherein the system positions the umbilical supply line in a pipe.

20. A system for positioning an umbilical supply line, the system comprising
an umbilical supply line comprising a plurality of catch structures positioned on, affixed to, and/or connected to the umbilical supply line;
an umbilical tether drive system comprising at least one drive element driven by a drive motor, the drive element having a plurality of protrusions, wherein each of the plurality of protrusions comprise a complementary shape to the plurality of catch structures positioned on, affixed to, and/or connected to the umbilical supply line; and
a reeling apparatus comprising an axle that receives the umbilical supply line therearound,
wherein upon the drive motor driving the at least one drive element, the umbilical tether drive system deploys and/or retracts the umbilical supply line from the reeling apparatus.

21. A system for controlling temperature and humidity conditions in a pipe, the system comprising:
an air conditioning apparatus configured to discharge air into a pipe;
at least one sensor configured to detect at least one of temperature, air velocity, and/or position of a centralizer; and
a control unit configured to adjust the air conditions in the pipe based on the data from the at least one sensor.

22. The system of claim 21, wherein the control unit is configured to adjust at least one of the temperature of the air discharged into the pipe, the humidity of the air discharged into the pipe, and/or the velocity of the air discharged into the pipe.

23. The system of claim 21, wherein the control unit is configured to adjust the air velocity in the pipe by controlling the dimension of an orifice positioned in the pipe.
